(19) United States
(12) Patent Application Publication
(10) Pub. No.: US 2009/0299992 A1
(43) Pub. Date: Dec. 3, 2009

(54) METHODS AND SYSTEMS FOR IDENTIFYING DESIRED INFORMATION

(76) Inventors: Doina Liliana Klinger, Winchester (GB); Lucas William Partridge, Southampton (GB); Nigel Daniels, Winchester (GB); Elisabetta Flamini, Eastleigh (GB)

Correspondence Address: WENDEROTH, LIND & PONACK, L.L.P., 1030 15th Street, N.W.,, Suite 400 East, Washington, DC, 20005-1503, US

(21) Appl. No.: 12/130,847

(22) Filed: May 30, 2008

(51) Int. Cl. G06F 17/30

(52) U.S. Cl. 707/5; 707/E17.014

(57) ABSTRACT

A method of identifying desired objects of information determines whether an existing rule is appropriate to identify a new desired object of information, defines a new rule to include at least one search query string when one of the existing rules is not appropriate to identify the new desired object of information, and defines an initial new search query string to identify the new desired object of information, wherein the initial search query string has a search query string input value. Furthermore, the method includes identifying objects having an object value equal to the search query string input value, and identifying the objects as the results of the processing operation and as having an equivalence relationship with the initial search query string. When the results do not satisfy the new rule, subsequent search query strings are defined to form a search query string chain.

### BACKGROUND OF THE INVENTION

This invention relates generally to identifying desired objects of information in computer systems, and more particularly, to a method for identifying desired objects of information by identifying equivalent relationships.

Known searching programs allow users to search for desired objects of information by implementing a variety of searches and iterating over intermediate steps, but the user is required to manually initiate the searches using the output from one search as the input for another search. Moreover, other known searching programs simply search for string pattern matches, making it very difficult for a user of these programs to chain the searches together to identify the desired information. Thus, because users may be required to analyze a large amount of information in order to identify the desired information, their productivity may decrease and the cost of developing products may increase.

### SUMMARY OF THE INVENTION

A method of identifying desired objects of information is provided that operates on a computer system including at least a server system, client sub-systems and a database. The method includes storing a plurality of existing rules on the database, wherein each of the existing rules is for identifying a different desired object of information and includes at least one search query string. Moreover, the method includes determining whether at least one of the existing rules is appropriate to identify a new desired object of information and when at least one appropriate rule exists processing the at least one rule, defining a new rule to include at least one search query string when at least one of the existing rules is not appropriate to identify the new desired object of information, and defining an initial new search query string constructed to identify the new desired object of information. The initial search query string has a search query string input value. Furthermore, the method includes entering an input parameter for the initial search query string, processing the initial search query string, identifying objects having an object value equal to the search query string input value, and identifying the objects as results of the processing operation and as having an equivalence relationship with the initial search query string, wherein the search query string input value and the object value can be related to each other via an equality, a table, a hash map or a mapping relationship.

The method also includes deciding whether the results for the initial search query string satisfy the new rule. When the results do not satisfy the new rule a subsequent search query string is defined that incorporates the results, and the processing, identifying and deciding operations are repeated for subsequent search query strings, such that the initial search query string and successive subsequent search query strings form a search query string chain, until results of subsequent search query strings satisfy the new rule. When the results satisfy the new rule the objects are identified as the new desired objects of information, the results are identified as the final result, and the new rule, including at least the initial search query string, is stored in the database. The final result is displayed on a monitor included in the computer system and the final result is stored in the database.

### BRIEF DESCRIPTION OF THE DRAWINGS

FIG. 1 is a simplified block diagram of an exemplary embodiment of a computer system for automatically resolving a sequence of equivalence relationships;

FIG. 2 is an expanded block diagram of an exemplary embodiment of a server architecture of the system shown in FIG. 1;

FIG. 3 is a flowchart illustrating an exemplary method for automatically resolving sequences of relationships;

FIG. 4 is a block diagram illustrating exemplary search results generated according to the method of the exemplary embodiment.

### DETAILED DESCRIPTION OF THE INVENTION

The methods and systems described herein facilitate quickly and accurately identifying desired objects of information in computer programs, otherwise known as software, during operation of a computer program. The methods and systems described herein are believed to be applicable to different types of programs that are used in many different businesses for quickly and accurately identifying desired objects of information concerning problems or errors in computer program code. The example embodiment described herein relates directly to the computer software business. Although the computer software business is the example business described herein, the invention is in no way limited to the computer software business. For example, the invention may also be used in the home appliance repair business to quickly and accurately identify appropriate technicians for repairing home appliances. It should be appreciated that the term “software” as used herein includes any kind of computer program that might develop problems or errors.

Exemplary embodiments of systems and processes that facilitate integrated network-based electronic identification of desired objects of information in software are described below in detail. The systems and processes facilitate, for example, quickly and accurately identifying desired objects of information in software using rules stored in a computer system. A technical effect of the systems and processes described herein include at least one of permitting an entity to accurately and quickly identify the causes of error messages output by running software code based on the results of previous search query strings. More specifically, in the example embodiment, computer programmers or other individuals engaged in the business of providing properly functioning software, utilize the methods and systems of the example embodiment to chain successive search queries together. Moreover, users of the methods and systems of the example embodiment are able to quickly and accurately identify desired objects of information, such as the location of an error message in software code by determining equivalence relationships of search query strings, or assignments, instead of merely identifying occurrences of the search query string itself. As another example, the invention may also be used in the resolution of resource references referred to by developers in their source code to actual resources such as databases, queues or other program modules assigned to the references at application deployment time.

In the exemplary embodiment, rules stored on a computer system are utilized to quickly and accurately identify desired objects of information relating to software code. At least some of the parties that may be involved in these systems and processes include businesses, system administrators and operators. Businesses refers to those entities that may develop software and those entities that may purchase and use the software. System administrator refers to the individuals who maintain the computer system. Users refer to computer programmers who develop software and need to accurately identify desired objects of information such as errors in software, and to users of the software after it has been developed by the computer programmers.

In the example embodiment, users of the computer system are able to perform many tasks, such as, but not limited to, quickly and accurately identifying desired objects of information relating to software code.

In the example embodiment, a user runs a program on a computer system. While the program is running, a software problem, or error, develops that must be resolved. The user prompts the computer system to search for the problem by either choosing an existing rule or generating a new rule. When the user decides to generate a new rule, an initial search query string is defined and processed, and the results of the initial search query string are evaluated to determine if they satisfy the rule. If not, the results of the initial search query string are incorporated in a subsequent search query and the process repeats itself until the rule is satisfied. Thus, successive search query strings are chained together. Moreover, during the search, equivalence relationships, or assignments, in addition to occurrences, are detected between the results of each search query string.

It should be appreciated that although the example discussed above is from the software development business, the searching tool may be used to implement search queries in any other business or field of endeavor requiring accurate identification of desired information. However, it should be further appreciated that other businesses or organizations may define different criteria for finding and identifying desired information depending on the particular business, and that for each business, the criteria may be different.

In one embodiment, a searching tool comprising a computer program is provided, and the computer program is embodied on a computer-readable medium with a user interface for administration and an interface for standard input and generating reports. In an exemplary embodiment, a computer system is run on a business-entity intranet. In a further exemplary embodiment, the system is run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independently and separately from other components and processes described herein. Each component and process also can be used in combination with other assembly packages and processes.

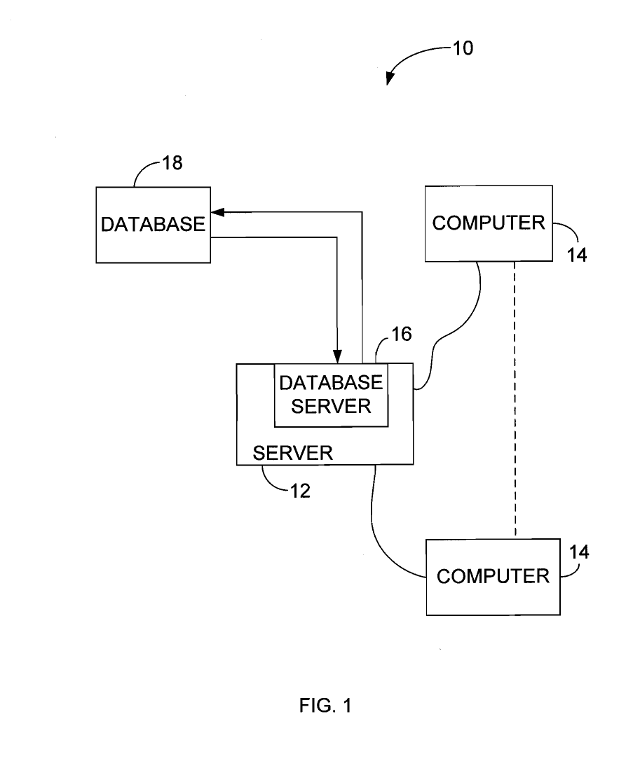

FIG. 1 is a simplified diagram of a computer system 10 including a server system 12, and a plurality of client sub-systems, also referred to as client systems 14, connected to server system 12. Computerized modeling and grouping tools, as described below in more detail, are stored in server 12 and can be accessed by an operator at any one of client systems 14. A database server 16 is connected to a database 18 containing information on a variety of matters, as described below in greater detail. In one embodiment, centralized database 18 is stored on server system 12 and can be accessed by potential users at one of client systems 14 by logging onto server system 12 through one of client systems 14. In an alternative embodiment, database 18 is stored remotely from server system 12 and may be non-centralized.

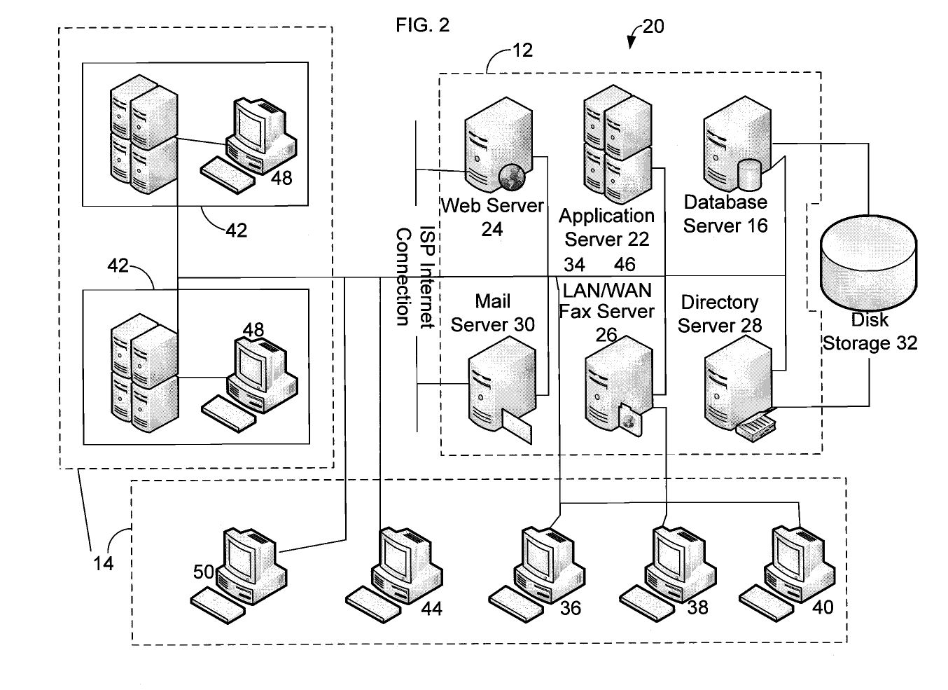

FIG. 2 is an expanded block diagram of an exemplary embodiment of a server architecture of a computer system 20. Components in system 20, identical to components of system 10 (shown in FIG. 1), are identified in FIG. 2 using the same reference numerals as used in FIG. 1. Computer system 20 includes server system 12 and client systems 14. Server system 12 further includes database server 16, an application server 22, a web server 24, a fax server 26, a directory server 28, and a mail server 30. Disk storage unit 32 is coupled to database server 16 and directory server 28. Servers 16, 22, 24, 26, 28 and 30 are coupled in a local area network (LAN) 34. In addition, a system administrator's workstation 36, a user workstation 38, and a supervisor's workstation 40 are coupled to LAN 34.

Each workstation 36, 38 and 40 is a personal computer. Although the functions performed at the workstations typically are illustrated as being performed at respective workstations 36, 38 and 40, such functions can be performed at one of many personal computers coupled to LAN 34. Workstations 36, 38 and 40 are illustrated as being associated with separate functions only to facilitate an understanding of the different types of functions that can be performed by individuals having access to LAN 34.

Server system 12 is configured to be communicatively coupled to various individuals, including employees 42 and to third parties, e.g., clients/customers 44, using LAN 34. The communication in the exemplary embodiment is illustrated as being performed using LAN 34, however, any other wide area network (WAN) 46 type communication can be utilized in other embodiments, i.e., the systems and processes are not limited to being practiced using LAN 34. In addition, and rather that LAN 34, wide area network 46 or the internet could be used in place of LAN 34.

In the exemplary embodiment, any authorized individual having a workstation 48 can access computer system 20. At least one of the client systems 14 includes a manager workstation 50. Workstations 48 and 50 are personal computers configured to communicate with server system 12. Furthermore, fax server 26 communicates with client systems 14, including manager workstation 50 using a telephone link. Fax server 26 is configured to communicate with other client systems 36, 38 and 40 as well.

Workstations 36, 38, 40, 48 and 50 include computers that may include a device, such as, but not limited to, a floppy disc drive or CD-ROM drive, for reading data including methods for automatically resolving sequence of equivalence relationships from a computer-readable medium, such as a floppy disc, a compact disc-read only memory (CD-ROM), a magneto-optical disc (MOD), or a digital versatile disc (DVD). Moreover, workstations 36, 38, 40, 48 and 50 include display devices, such as, but not limited to, liquid crystal displays (LCD), cathode ray tubes (CRT) and color monitors. Furthermore, workstations 36, 38, 40, 48 and 50 include input devices such as, but not limited to, a mouse (not shown), keypad, (not shown), a keyboard (not shown), and a microphone (not shown).

Application server 22 includes a processor (not shown) and a memory (not shown). It should be understood that, as used herein, the term processor is not limited to just those integrated circuits referred to in the art as a processor, but broadly refers to a computer, an application specific integrated circuit, and any other programmable circuit. It should be understood that the processor executes instructions, or computer programs, stored in application server 22 memory (not shown). The above examples are exemplary only, and are thus not intended to limit in any way the definition and/or meaning of the term “processor.”

The memory (not shown) can be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like.

The memory (not shown) is used to store executable instructions, or computer programs, thereon. The term “computer program” is intended to encompass an executable program that exists permanently or temporarily on any computer-readable medium.

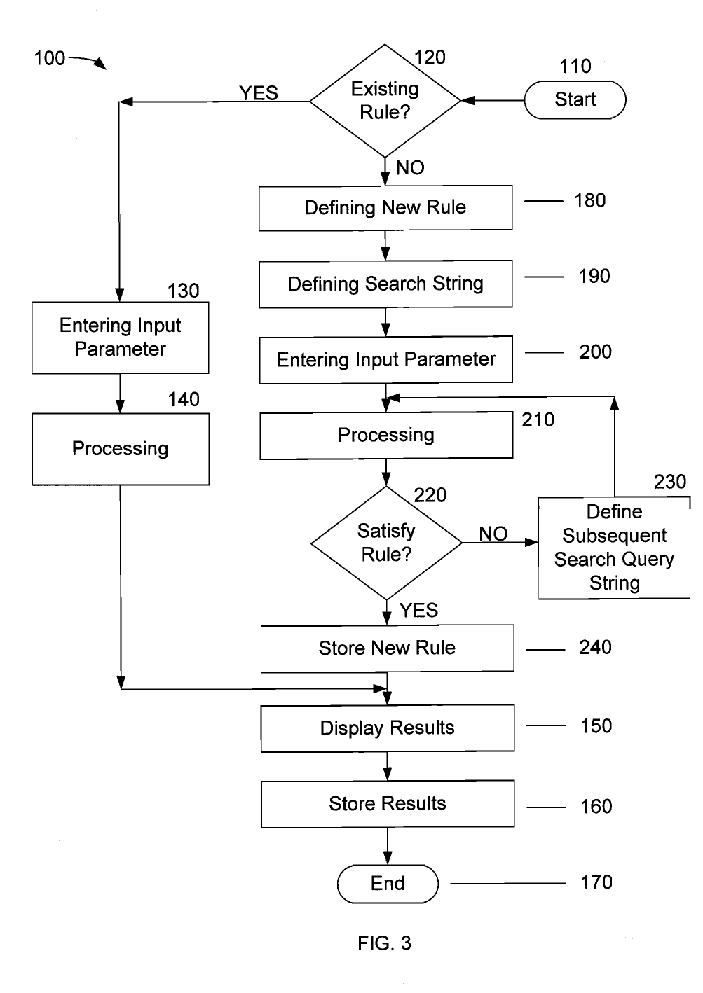

FIG. 3 is a flowchart 100 illustrating an exemplary method for identifying desired objects of information. The method starts 110 by deciding that a search to identify desired objects of information is required. It should be understood that particular rules are established to perform particular searches to find and identify desired objects of information, and that the rules themselves include search query strings constructed to search for the desired information. Moreover, in the exemplary embodiment, existing rules are stored in the storage unit 32 and new rules may be defined to find and identify different new desired objects of information. Thus, after determining that an appropriate rule exists in the storage unit 32, a user may search for new desired objects of information by choosing 120 the appropriate existing rule that finds and identifies the desired object of information.

Generally, users are required to enter an input parameter 130 to effectively implement the search after choosing the existing rule 120. After entering the input parameter 130, processing, or running, 140 the existing rule generates search results that are displayed 150 to the user. In the exemplary embodiment, only a final search result is presented to the user on a computer monitor display 150 and the user has the option of storing the final result 160. However, it should be appreciated that in other embodiments, each user may select which results to display 150 and store 160. For example, in other embodiments, the user may choose to display 150 and store 160 the intermediate and final search results. Moreover, the user may choose to display 150 only the final result of the search and store 160 all of the search results. After displaying 150 and storing 160 the search results, processing of the rule ends 170. However, if it is decided that an appropriate rule does not exist 120 that searches for the new desired objects of information, a new rule is defined 180 that searches for the desired information.

Defining a new rule 180 includes establishing a purpose of the rule which generally corresponds to the desired object of information. Thus, in the exemplary embodiment, because the user would like to find an error in program code, the rule is defined as “finding the cause of a computer program error.” After defining the rule 180, the user defines search query strings 190 to implement the rule by finding and identifying the computer program error.

In the exemplary embodiment, an initial search query string is defined 190 as “finding all constants or variables in a set of Java source code files which are assigned to a particular input parameter.” It should be appreciated that this initial search query string may be any desired expression. Next, the user enters “A” as the particular input parameter 200. After entering the input parameter 200, processing, or running, the search query string 210 generates the results of the initial search query string. The results are presented to the user on a computer monitor, and if the user determines that the results of the initial search query string do not satisfy the rule 220, the user defines a subsequent search query string 230 that incorporates the results of the initial search query.

In the exemplary embodiment, the results of the initial search query string yield only one match, that is, B=A. The user determines that this result does not satisfy the rule 220, and defines a subsequent or second search query string 230 as “performing a database SQL (Structured Query Language) query to find all row values which equal B.” The second query string is processed 210, and generates the results of the second query string as “C.” The user determines that the result “C” does not satisfy the rule 220, and defines another subsequent, or third, search query string 230 as “looking-up in an in-memory hash table all values which map to C.” The third search query string 210 is processed, and generates results of the third query string as “D.” The user determines that the result “D” does not satisfy the rule 220, and defines another subsequent, or fourth, search query string as “parse an XML file to find all elements called ‘Error’ whose attribute called ‘message’ equals D.” The fourth search query string 210 is processed, and generates results of the fourth query string as “E.” The user determines that the result “E” satisfies the rule 220, and stores all the search query strings included in the rule 240 in storage unit 32 as the new rule. It should be understood that in the exemplary embodiment, the subsequent search query strings incorporate the results of the immediately preceding search query string to refine the search, and that by repeatedly creating such search query strings, the search query strings are effectively chained together to form a search query string chain, until the new rule is satisfied.

As discussed above with regard to an existing rule, when defining a new rule in the exemplary embodiment, only the final search result is presented to the user on the computer monitor display 150 and the user has the option of storing the final result 160. However, it should be appreciated that in other embodiments, each user may select which results to display 150 and store 160. For example, in other embodiments, the user may choose to display 150 and store 160 the intermediate and final search results. Moreover, the user may choose to display 150 only the final result of the search and store 160 all of the search results. After displaying 150 and storing 160 the search results, processing ends 170.

Thus created and stored 240, the new rule can be automatically retrieved from the storage unit 32 and processed 140 as an existing rule at a later time using a different initial input parameter. For example, instead of using “A” as the initial input parameter, a user may use “Connection failure!” Upon entering “Connection failure!” 130 and running the new rule 140, the user will be presented with the final result of the search which indicates that the “User has unplugged their computer from the network,” and will not receive any intermediate search query string results.

It should be appreciated that in the exemplary embodiment, when determining the results of search query strings, the computer system searches for equivalence relationships or assignments of an input value of the search query string, not merely occurrences of the input value. Each search query string has an input value and each object of information is assigned a value. Thus, objects of information that are assigned the same value as, or that is equivalent to, the input value of the search query string, are determined as results of the search query string. Thus, when the value of a search query strings' input value and an object's value are the same, there is an equivalence relationship between them.

It should be understood that the values for determining equivalence relationships as described herein may be defined in the form of tables, hash maps or any form of 1:1 (or 1:n) mapping relationship. Thus, the exemplary embodiment as described herein is not restricted to finding objects that are the same type, or subtype, as each other in a strict programmatic sense.

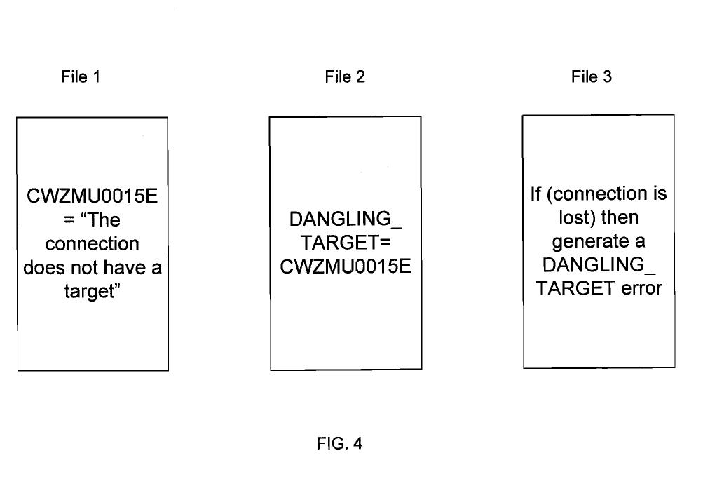

FIG. 4 is a block diagram illustrating exemplary search results used for explaining the concept of equivalence. As shown, FIG. 4 includes three exemplary files File 1, File 2 and File 3 that are included as part of a search to determine the location in a computer application's source code of a program error that a user of the application has reported as seeing at runtime. In this case, the user has reported seeing the error “The connection does not have a target” and the developer responsible for servicing the application wishes to locate the precise location(s) in the source code that give rise to this error. It should be appreciated that error messages in a particular spoken language are normally listed in files like that shown in File 1. The program developer that received the error normally manually searches through File 1 until “CWZMU0015E” is found. After finding “CWZMU0015E,” the developer manually searches through File 2 to determine that “CWZMU0015E” is the code for “DANGLING_TARGET.” Then, by manually searching for occurrences of “DANGLING_TARGET” in the program's source code the developer discovers that the cause of the problem is actually a lost connection. It should be understood that, conventionally, developers manually search by copying the results of search query strings as the input for subsequent search query strings. Moreover, it should be appreciated that developers manually search by initiating each of the search query strings, including the second search query string to a last search query string.

File 1 illustrates the string “The connection does not have a target,” once, but it may occur several times in File 1. Thus, “CWZMU0015E” is equivalent to “The connection does not have a target.” Moreover, as shown in File 2, “DANGLING_TARGET” is equivalent to “CWZMU0015E.” In contrast to the exemplary embodiment, known computer searching techniques simply list all occurrences of the original search query string (i.e., “The connection does not have a target”), and users manually search for any assignments.

In the exemplary embodiment of the invention as described herein, instead of manually searching for an error, a rule including search query strings is used to search for equivalence relationships, or assignments, to facilitate finding the error. Thus, upon receiving the error “The connection does not have a target,” a user simply applies the existing appropriate rule and is automatically taken to File 3 which tells him the point in the program where a lost connection has been identified and that he can investigate further. However, if an appropriate rule does not exist, a user develops a new rule and associated search query strings that can be used repeatedly for future searches. Consequently, the exemplary embodiment as described herein, facilitates reducing the time required to discover errors, or find desired objects of information.

It should be understood that in the exemplary embodiment, each rule and associated search query strings may be applied to any arbitrary type and mixture of resources within which an equivalence relationship is defined. These resources include, but are not limited to, computer files, computer memory, database entry and computer tables. It should be appreciated that rules may include any kind of search query that facilitates finding the particular desired information in any computer file or any computer component of a computer system. Moreover, the search queries may define at least one computer language for conducting the searches.

Equivalence relationships are used to determine the result of a search to facilitate reducing the amount of time required for such searches. Objects that are assigned the value of, or are equivalent to, a search query string, are determined as equivalence relationships and consequently are the results of the search. The equivalence relationships may be defined in any form, such as, but not limited to, tables, hash maps, or any form of 1:1 (or 1:n) mapping relationship.

1:1 mapping is when only one value, or result, is found to be equivalent to a search query string input value. 1:n mapping is when more than one value, or result, is found to be equivalent to a search query string input value, and may occur in at least one of the search query strings in the search query string chain. It should be appreciated that each result forms a branch with the search query string it is generated from and is processed as described in the flowchart of FIG. 3. In the exemplary embodiment, the system is configured to accept and store the results of such branching automatically, with suitable constraints to prevent exponential recursion. In other embodiments, the system could be prompted to halt as soon as it detects a branching (that is, multiple results from a single search query string) and then prompt the user to select the branch along which subsequent steps in the search chain would be allowed to proceed.

The present invention can be directed to a system or an apparatus for reducing the time required to find desired objects of information using equivalence relationships. Moreover, the present invention can also be implemented as a program for causing a computer to identify desired objects of information, and the program can be distributed via a computer-readable storage medium such as, but not limited to, a CD-ROM.

While the invention has been described in terms of various specific embodiments, those skilled in the art will recognize that the invention can be practiced with modification within the spirit and scope of the claims.

The invention is claimed as follows:

1. A method of identifying desired objects of information, wherein a computer system includes at least a server system, client sub-systems and a database, said method comprising:
storing a plurality of existing rules on the database, wherein each of the existing rules is for
identifying a different desired object of information and comprises at least one search query string;
determining whether at least one of the existing rules is appropriate to identify a new desired object of information and when at least one appropriate rule exists, processing the at least one rule;
defining a new rule to include at least one search query string when at least one of the existing rules is not appropriate to identify the new desired object of information;
defining an initial new search query string constructed to identify the new desired object of
information, wherein the initial search query string has a search query string input value;
entering an input parameter for the initial search query string;
processing the initial search query string;
identifying objects having an object value equal to the search query string input value;
identifying the objects as results of said processing operation and as having an equivalence relationship with the initial search query string, wherein the search query string input value and the object value are one of a table, a hash map and a mapping relationship;
deciding whether the results for the initial search query string satisfy the new rule,
when the results do not satisfy the new rule a subsequent search query string is defined that incorporates the results, and said processing, identifying and deciding operations are repeated for subsequent search query strings, such that the initial search query string and successive subsequent search query strings form a search query string chain, until results of subsequent search query strings satisfy the new rule, and
when the results satisfy the new rule the objects are identified as the new desired
objects of information, the results are identified as the final result, and the new rule, including at least the initial search query string, is stored in the database;
displaying the final result on a monitor included in the computer system; and
storing the final result in the database.
